(19) United States
(12) Patent Application Publication
(10) Pub. No.: US 2019/0263311 A1
(43) Pub. Date: Aug. 29, 2019

(54) Dump Body

(71) Applicant: Eric Robbs, Post Falls, ID (US)

(72) Inventor: Eric Robbs, Post Falls, ID (US)

(73) Assignee: Ground Force Worldwide, Post Falls, ID (US)

(21) Appl. No.: 16/344,897

(22) PCT Filed: Oct. 25, 2017
(86) PCT No.: PCT/US17/58367

§ 371 Date: Apr. 25, 2019

Related U.S. Application Data
(60) Provisional application No. 62/413,733, filed on Oct. 27, 2016.

(51) Int. Cl. B60P 1/28; B23K 31/02

(52) U.S. Cl. CPC B60P 1/286; B23K 2101/006; B23K 31/02

(57) ABSTRACT

Representative implementations of devices and techniques provide a dump body (e.g., dump bed, dump tray, etc.) for a dump truck, for example. The dump body, which has a semi-elliptical shape, includes a shell portion comprising a plurality of contoured body panels. The body panels are welded together in an overlapped arrangement with laminated seams.

### PRIORITY CLAIM AND CROSS-REFERENCE TO RELATED APPLICATION

This application claims the benefit under 35 U.S.C. § 119(e)(1) of U.S. Provisional Application No. 62/413,733, filed Oct. 27, 2016, and of PCT International Application No. PCT/US17/58367, filed Oct. 25, 2017, both of which are hereby incorporated by reference in their entirety.

### BACKGROUND

Dump trucks and like vehicles are widely used in the mining industry, as well as other industries, for moving large quantities of materials from location to location. Generally, a dump truck includes a dump body configured to hold the materials to be moved, pivotally mounted to a truck chassis. The dump body is pivotally attached to the chassis (or frame) of the truck so that the dump body can be loaded while in a first position relative to the truck chassis and so that it can be oriented into a second position for unloading.

When the dump body is in the first position relative to the chassis of the truck (e.g., a rest position), the dump body may be loaded or filled as desired. For instance, the dump body may be filled with rocks, raw minerals, dirt, and the like, to be transported away from a work site (such as a mining dig site, for instance) or to a processing site, a fill site, etc. To unload the dump body, the dump body is moved into the second position (e.g., an extended or tilted position). While in the extended position, materials within the dump body are spilled out of an opening at the lowest point (e.g., the back end) of the dump body.

Accordingly, a dump body is generally manufactured of materials that are harder than the materials to be hauled within the dump body. This reduces wear on the dump body, and particularly at locations of the dump body where the hauled materials move against the surface of the dump body. It is also desirable that the dump body be formed or manufactured to be strong, to be capable of enduring many heavy loads without material or manufacturing failures. However, it is also desirable that the dump body be as light as practical for the desired volume of the dump body, to optimize the amount of material that can be transported with each load (since the weight of the dump body adds to the gross weight of the loaded vehicle, and the vehicle has a maximum gross weight capability) as well as to minimize the amount of fuel that is used to transport each load.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes and/or dimensions shown in the illustrations of the figures are for example, and other shapes and or dimensions may be used and remain within the scope of the disclosure, unless specified otherwise.

FIG. 1 shows an example dump truck, as an example application environment for an example dump body as disclosed herein.

FIG. 2 shows a front perspective view of an example dump body, according to an implementation.

FIG. 3 shows a back perspective view of an example dump body, according to an implementation.

FIG. 4 shows a top perspective view of an example dump body, according to an implementation.

FIG. 5 shows a bottom perspective view of an example dump body, according to an implementation.

FIG. 6 shows a side view of an example dump body, according to an implementation.

FIG. 7 shows a top view of an example dump body, according to an implementation.

FIG. 8 shows a front view of an example dump body, according to an implementation.

FIG. 9 shows a bottom view of an example dump body, according to an implementation.

FIG. 10 shows a back view of an example dump body, according to an implementation.

FIG. 11 shows a detail view of example weld seams of an example dump body, according to an implementation.

FIG. 12 is a flow diagram illustrating an example dump body manufacturing process, according to an implementation.

### DETAILED DESCRIPTION

### Overview

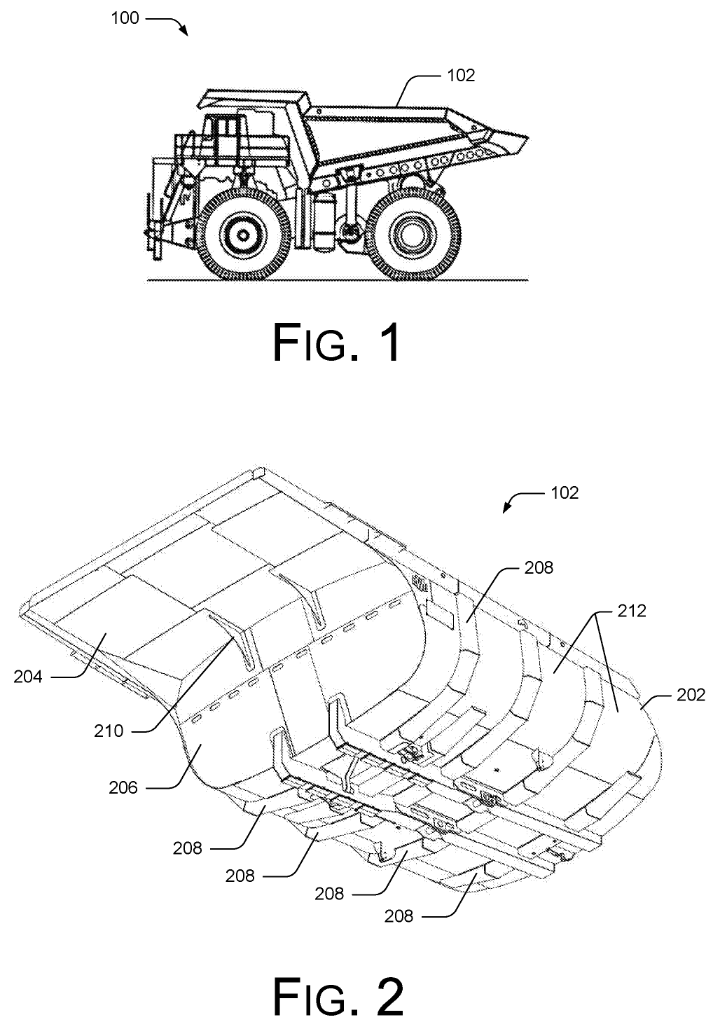

Representative implementations of devices and techniques provide a dump body (e.g., dump bed, dump tray, etc.) for a dump truck, for example. An example dump truck 100, having an example dump body 102, is shown in FIG. 1. The illustration of FIG. 1 is not intended to be limiting, however. The dump truck 100 and the dump body 102 may be of various sizes, and may have various dimensions and configurations, and include various accessories.

For example, in various implementations, the dump body 102 is custom engineered (e.g., in size, dimensions, capacity, construction materials, attachment points, etc.) for a desired application, including being custom fit for a particular truck 100, or for a range of trucks 100. In a range of applications, a dump body 102 may be designed for carrying 40 tons to 400 tons of material (corresponding to a gross vehicle weight of about 157,000 lbs. to 1,375,000 lbs., respectively, on haul trucks having a corresponding chassis weight of about 70,000 lbs. to 600,000 lbs., respectively). In other applications, a dump body 102 may be designed for lesser or greater load-carrying capacity.

The dump body 102 is pivotally attached to the chassis (or frame) of the truck 100. When the dump body 102 is in a first position (e.g., a rest position, as shown in FIG. 1) relative to the chassis of the truck 100, the dump body 102 may be loaded or filled as desired. For instance, the dump body 102 may be filled with rocks, raw minerals, dirt, and the like, to be transported away from a work site (such as a mining dig site, for instance) or to a processing site, a fill site, etc.

To unload the dump body 102, the dump body 102 is moved into a second position (e.g., an extended or tilted position). While in the extended position, materials within the dump body 102 are spilled out of an opening at the lowest point (e.g., the back end) of the dump body 102.

### Example Dump Body

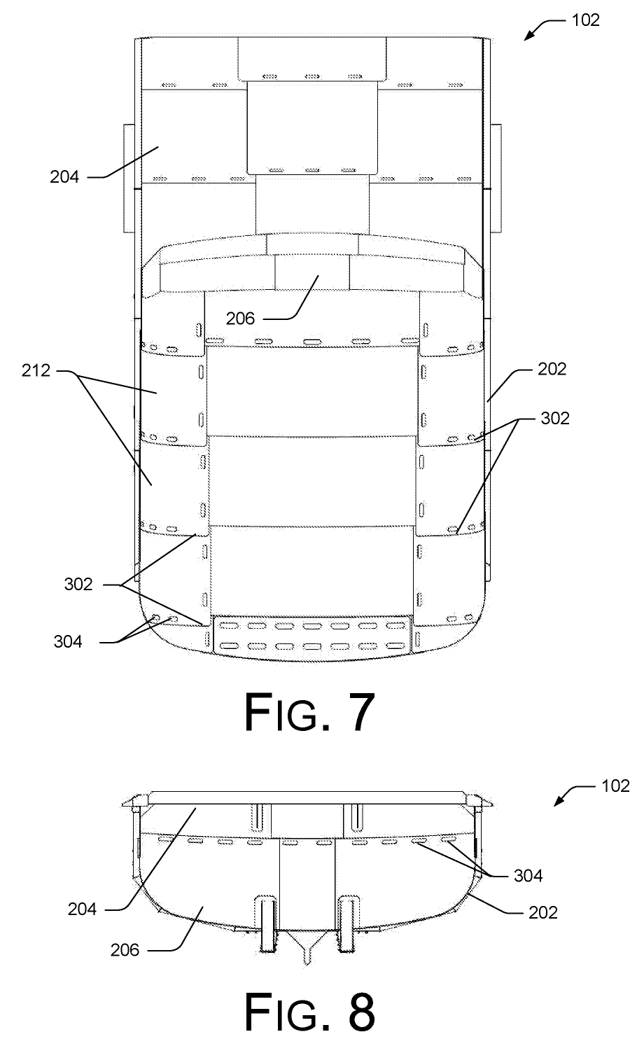

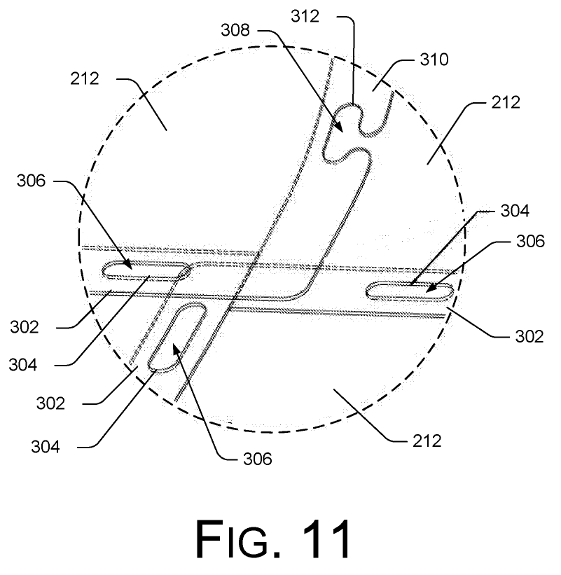

As shown in FIGS. 2-10, a dump body 102 may include a shell 202 and a canopy 204. For example, the shell 202 includes the portion of the dump body 102 that is intended to be filled and/or to carry a load. As shown in FIGS. 2-10, in various implementations, the dump body 102 includes a curved or semi-elliptical shaped shell 202. The front head 206 forms the front portion of the shell 202, and it may be planar or curved overall. As shown in FIG. 2, the perimeter of the front head 206 illustrates the curved or semi-elliptical shape of the shell 202. The canopy 204 includes the portion of the dump body 102 ahead of the shell 202 that covers and protects the cab of the truck 100. In alternate embodiments, the canopy 204 may not extend over the cab of the truck 100, or may not be present on the dump body 102.

The novel curved or semi-elliptical shape of the shell 202 provides maximum strength with reduced overall weight (as compared to traditional rectangular-shaped dump body shells), to maximize load-carrying capacity, which improves efficiency. For instance, a dump body 102 with a curved or semi-elliptical shaped shell 202 is capable of carrying significantly more load than a similarly weighted traditional rectangular-shaped dump body shell.

Referring to FIGS. 2-6, 9, and 10, in various embodiments, the dump body 102 also includes one or more bolsters 208 to provide strength and stability to the shell 202, and one or more gussets 210 to support the canopy 204 relative to the shell 202. In alternate implementations, no bolsters 208 and/or no gussets 210 may be used with the shell 202. For instance, the shell 202 may have sufficient strength (due to the size, construction, materials, etc. of the shell 202) without the bolsters 208 and/or gussets 210.

As shown in FIGS. 2-10, in various embodiments, the dump body 102 is comprised of multiple curved (contoured, bent, radiused, rolled, etc.) body panels 212, which are welded together, for example, to form the curved or semi-elliptical shaped shell 202. In some embodiments, the dump body 102 also includes multiple flat (planar) body panels 212, as shown. In various implementations, the panels 212 may be comprised of aluminum, mild steel, alloy steel, tool steel, or other metallic plate and the like.

The body panels 212 are welded with overlapping seams 302, as illustrated in FIGS. 3, 4, 7, and 11, which form laminated seams 302 for increased structural support. The overlapping seams 302 allow for a reduced number of external structural supports (e.g., bolsters 208, etc.), which reduces the weight of the dump body 102 without compromising strength or capacity of the dump body 102. In various embodiments, the panel 212 overlap, and resulting laminated seams 302 can have a width of between 2 and 30 centimeters. In alternate embodiments, the overlap and resulting seams 302 can have a width that is less than 2 cm or greater than 30 cm.

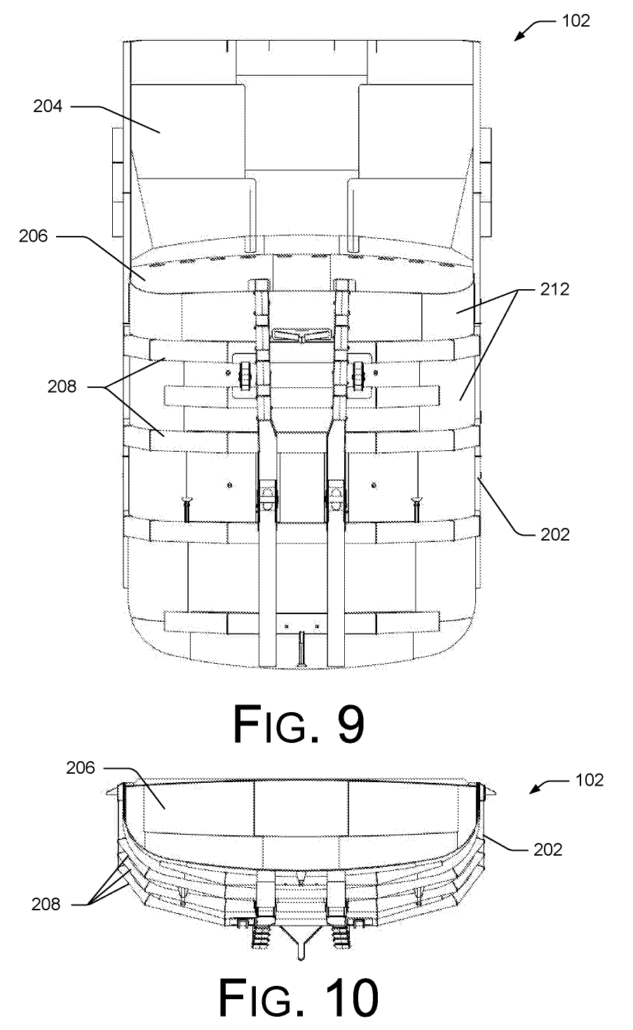

As shown in FIGS. 3, 4, and 7, the overlap of the body panels 212 follows a front-to-rear “step-down” overlap arrangement, where a leading edge of each successive panel 212 is attached to the underside trailing edge of the previous (preceding) panel 212 (when looking from the inside surface of the dump body 102, see top view of FIG. 7 for example). This results in an approximately 1 degree flare from the front to the rear of the shell 202. The “step-down” overlap arrangement allows for quick and full material release when unloading the shell 202. Additionally, the “step-down” overlapping design causes the load materials to flow over, rather than across the welds at the seams 302 joining the panels 212 during unloading of the shell 202.

Thus, the “step-down” overlap design protects the weld seams 302 along the edges of the panels 212 from damage or wear due to the material flow out of the shell 202. For instance, much of the materials flowing out of the shell 202 during unloading does not directly impact the welds, which can be comprised of a softer material than the body panels 212. Rather, the material flow is directed over the welds by the “step-down” overlap arrangement.

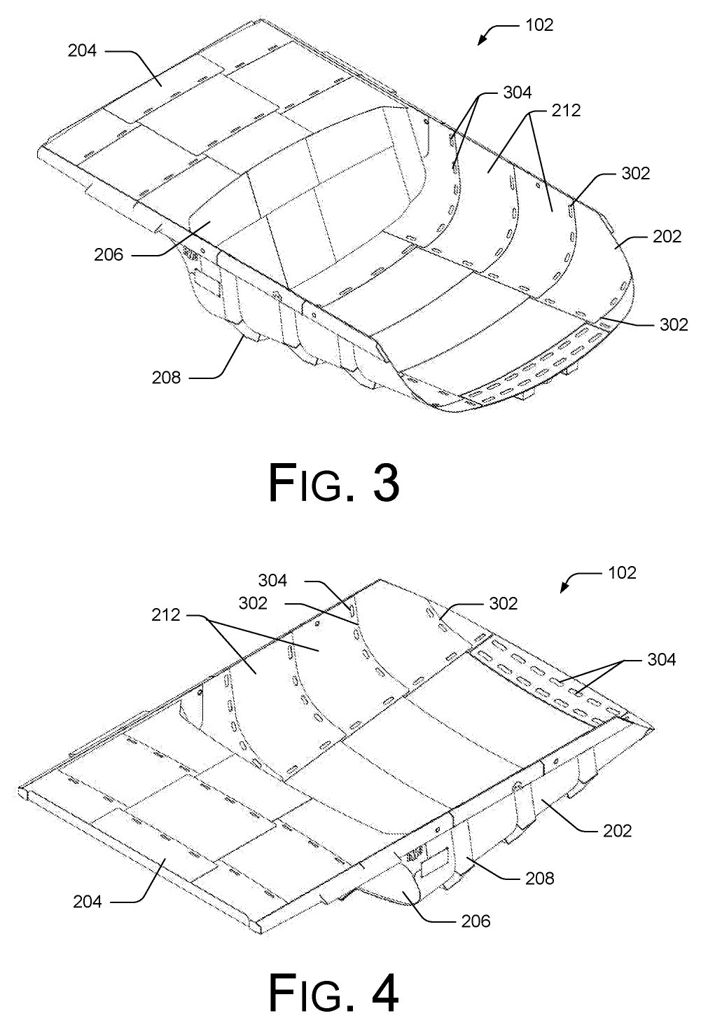

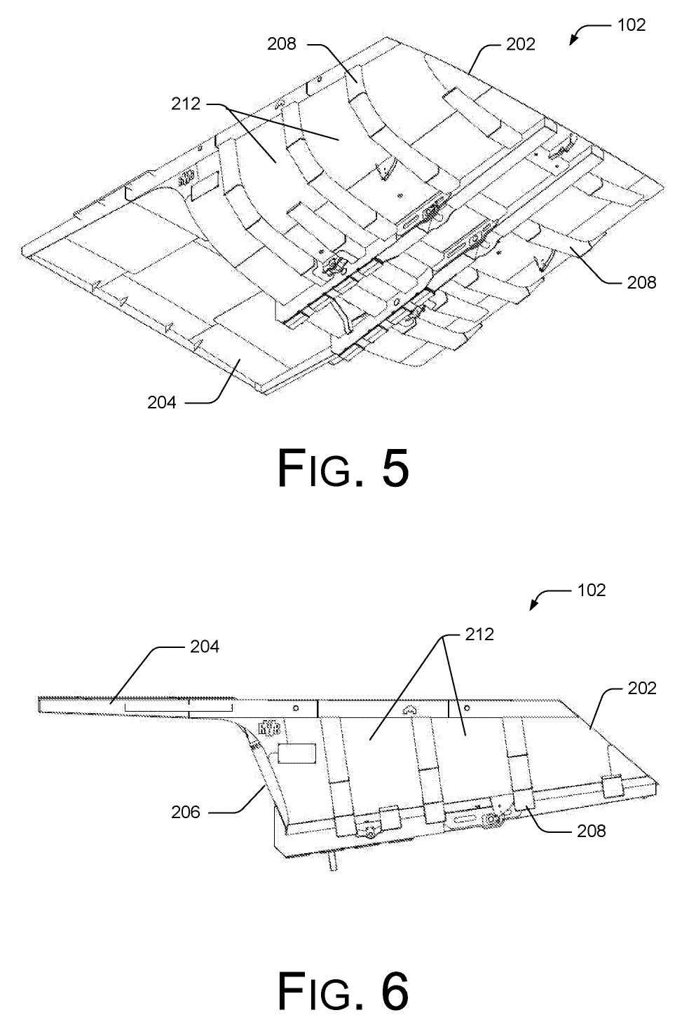

In various implementations, the overlapping panels 212 are welded at the overlapping seams 302, where the edges of the panels 212 overlap. Additionally or alternately, as shown in FIGS. 3, 4, 7, and 11, plug welds 304 may be used to weld the overlapping seams 302. A plug weld 304 includes an opening 306 through a first layer (e.g., the upper layer) of the overlapping seam 302 of panels 212 that exposes a second layer (e.g., the lower layer) of the overlapping seam 302 through the opening 306. The first layer panel 212 of the overlapping seam 302 is welded to the second layer panel 212 within the opening 306, at the periphery of the opening 306. In various implementations, the plug welds 304 may be made on the inside of the dump body 102, as shown in FIGS. 3 and 4 for example, on the outside of the dump body 102, or a combination of on the inside and on the outside of the dump body 102, if desired.

In various implementations, the plug welds 304 are located along the seams 302 at predetermined points for strength and for optimized wear. For example, a weld around the opening 306 (i.e., at the periphery) of the plug weld 304 provides approximately three times the weld length (and an associated strength) of a standard beveled welded joint. Additionally, the weld bead of a plug weld 304 is generally protected against wear and damage, since it is located within the “pocket” of the opening 306.

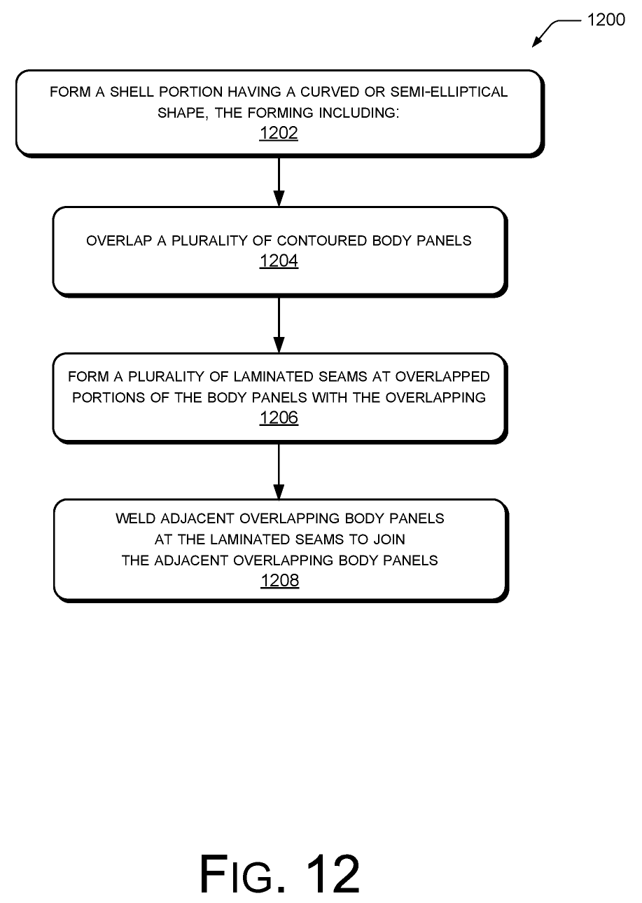

As also shown at FIG. 11, in an implementation, one or more of the edges of some or all of the body panels 212 of the dump body 102 are “formed” (e.g., serrated, notched, toothed, scalloped, indented, curved, patterned, embellished, or otherwise fashioned with regular or irregular patterns), to have other than a generally straight edge (one example is shown at 308). Overlapping one or more body panels 212 with “formed” edges creates an overlapped “formed” seam 310, and welding along the “formed” edge of the “formed” seam 310 creates a “formed” weld 312. In various implementations, the “formed” welds 312 are located along the “formed” seams 310 at predetermined points for strength and for optimized wear. For example, a “formed” weld 312 along a “formed” edge can also provide additional weld length (and an associated strength) as compared to a generally straight, standard beveled welded joint. Additionally, at least portions of the weld bead of a “formed” weld 312 may be protected against wear and damage, based on the pattern of the “formed” weld 312 relative to the general flow of material out of the shell 202 when the dump body 102 is emptied.

In embodiments where multiple types of welds (i.e., edge welds, plug welds, and/or “formed” welds, or other types of welds) are used, one weld type reinforces the other weld type, with the combination resulting in a much stronger shell 202 for its weight.

In some embodiments, additional plug welds 304 (or “formed” welds 312) may be used to reduce or eliminate the delamination process of the shell 202. Delamination includes the separation of the panels 212 at the seams 302. The additional plug welds 304 and/or “formed” welds 312 strengthen the seams 302 against delamination.

In some embodiments, portions of the shell 202 may be lined, e.g., with harder, more wear resistant materials, etc. For example, one or more liner portions (not shown) may be placed within the shell 202 per user specifications, or the like.

In various implementations, the dump body 102 may be comprised of multiple modular portions (not shown), intended to be assembled at a designated site location. Delivery of the dump body 102 is facilitated when it is transported in smaller sections. For example, the dump body 102 may be manufactured in 2 or more modular portions, including dozens or more modular portions, with key assembly components (such as sub-frame and rear pin bosses, for example) pre-mounted on the modular portions before delivery. The dump body 102 can be easily assembled on site, based on the modular components.

The modularity of the dump body 102 is enhanced by the use of the multiple body panels 212. For instance, modular portions can be formed at the natural edges of some of the body panels 212, where seams 302 are to be formed. Additionally, the modular design of the dump body 102, using the panels 212, can allow for a staged build of the dump body 102 and can reduce manufacturing time. For instance, manufacturing time can be reduced due to the novel joint design (using the overlapping seams 302) and the welding techniques (applying edge welds at the overlap seams 302, at the plug welds 304, and/or the “formed” welds 312).

Although various implementations and examples are discussed herein, further implementations and examples may be possible by combining the features and elements of individual implementations and examples.

### Representative Process

FIG. 12 illustrates a representative process 1200 for implementing techniques and/or devices relative to forming a dump body arranged to hold a payload (such as dump body 102, for example). The process 1200 includes forming a plurality of contoured panels (such as body panels 212, for example) together to form the dump body. The example process 1200 is described with reference to FIGS. 1-12.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable hardware, software, firmware, or a combination thereof, without departing from the scope of the subject matter described herein.

At block 1202, the process includes forming a shell portion having a curved or semi-elliptical shape. The forming includes the remaining steps:

At block 1204, the process includes overlapping a plurality of contoured body panels.

At block 1206, the process includes forming a plurality of laminated seams at overlapped portions of the body panels with the overlapping.

At block 1208, the process includes welding adjacent overlapping body panels at the laminated seams to join the adjacent overlapping body panels.

In an implementation, the process includes forming a plurality of openings through an upper layer of each of the plurality of laminated seams that exposes a lower layer of each of the plurality of laminated seams, and welding around a periphery of each of the openings to join the lower layer of each of the plurality of laminated seams to the upper layer of each of the plurality of laminated seams. In an embodiment, the process includes welding inside each of the openings to form the plug welds within the openings.

In an implementation, the process includes protecting weld beads of the plug welds against wear and damage by locating the weld beads fully within the openings. This allows materials exiting the dump body to flow over the plug welds, rather than directly impacting the welds. Additionally, the process can include reducing or eliminating delamination of the body panels by forming the plug welds within the openings.

In another implementation, the process includes welding along edges of the plurality of body panels at the plurality of laminated seams to join adjacent and overlapping body panels at the plurality of laminated seams. In some embodiments, the process includes welding along “formed” edges of the body panels, where the edges have been “formed” (e.g., serrated, notched, toothed, scalloped, indented, curved, patterned, embellished, or otherwise fashioned with regular or irregular patterns), to have other than a generally straight edge. In the embodiments, the process can include protecting at least portions of the weld bead of the “formed” welds against wear and damage, based on the pattern of the “formed” weld relative to the general flow of material when the dump body is emptied. In various embodiments, the process can include using plug welds, seam welds, “formed” welds, or a combination of plug welds, “formed” welds, and/or seam welds to join the body panels. In alternate embodiments, other additional or alternate welding techniques may be employed.

In an additional implementation, the process includes lining an inside surface of the shell portion with a wear-resistant material that is harder than a material of the shell portion. This protects the softer material of the dump body, and allows for greater longevity.

In a further implementation, the process includes assembling the dump body from two or more modular portions, where each modular portion comprises a plurality of body panels. Forming the modular portions along the natural edges of the body panels can improve assembly times and manufacturing efficiency.

In alternate implementations, other techniques may be included in the process in various combinations, and remain within the scope of the disclosure.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing the claims. Further, individual features of various embodiments may be combined to form other embodiments not specifically described.

What is claimed is:

1. A dump body, comprising:
a shell portion arranged to hold a payload, the shell portion having a curved or semi-elliptical shape; the shell portion comprising:
a plurality of contoured body panels, the body panels overlapped to form laminated seams between the body panels; and
a plurality of welds adapted to join adjacent and overlapping body panels.

2. The dump body of claim 1, further comprising one or more plug welds arranged at the laminated seams between the body panels and adapted to join the adjacent and overlapping body panels.

3. The dump body of claim 2, wherein in a plug weld comprises an opening through a first layer of a laminated seam of the overlapping body panels that exposes a second layer of the laminated seam through the opening, the first layer body panel of the laminated seam being welded to the second layer body panel within the opening, at a periphery of the opening.

4. The dump body of claim 1, further comprising a plurality of seam welds arranged along edges of the body panels at the laminated seams and adapted to join the adjacent and overlapping body panels.

5. The dump body of claim 1, wherein an overlap of the body panels follows a front-to-rear step-down overlapping arrangement, wherein a leading edge of a successive panel is attached to an underside trailing edge of a preceding panel.

6. The dump body of claim 5, wherein the step-down overlapping arrangement directs material exiting the dump body to flow over the welds without directly impacting the welds.

7. The dump body of claim 1, further comprising one or more formed welds arranged along one or more formed edges of one or more of the body panels at the laminated seams, and adapted to join the adjacent and overlapping body panels, wherein the formed edges comprise edges that are serrated, notched, toothed, scalloped, indented, curved, patterned, embellished, or fashioned with regular or irregular patterns to have other than a generally straight edge, and wherein the formed welds comprise welds along the formed edges.

8. The dump body of claim 1, further comprising multiple modular portions formed of a quantity of the body panels, the modular portions arranged to be combined and field assembled to form the dump body.

9. A dump body, comprising:
a shell portion arranged to hold a payload, the shell portion including a curved or semi-elliptical shape; the shell portion comprising:
pluralities of planar and contoured body panels, the body panels overlapped in a front-to-rear step-down overlapping arrangement to form laminated seams between the body panels, wherein a leading edge of a successive panel is attached to an underside trailing edge of a preceding panel; and
a plurality of welds arranged at the laminated seams between the body panels, adapted to join adjacent and overlapping body panels.

10. The dump body of claim 9, further comprising a plurality of seam welds arranged along edges of the body panels at the laminated seams and adapted to add strength to the laminated seams.

11. The dump body of claim 9, further comprising a plurality of plug welds arranged at the laminated seams between the body panels and adapted to join the adjacent and overlapping body panels.

12. The dump body of claim 11, wherein in a plug weld comprises an opening through a first layer of a laminated seam that exposes a second layer of the laminated seam through the opening, the first layer being welded to the second layer using a weld bead within the opening, at a periphery of the opening.

13. A method of forming a dump body arranged to hold a payload, comprising:
forming a shell portion having a curved or semi-elliptical shape, the forming including:
overlapping a plurality of contoured body panels;
forming a plurality of laminated seams at overlapped portions of the body panels with the overlapping; and
welding adjacent overlapping body panels at the laminated seams to join the adjacent overlapping body panels.

14. The method of claim 13, further comprising forming a plurality of openings through an upper layer of each of the plurality of laminated seams that exposes a lower layer of each of the plurality of laminated seams, and welding around a periphery of each of the openings to join the lower layer of each of the plurality of laminated seams to the upper layer of each of the plurality of laminated seams.

15. The method of claim 14, further comprising welding inside each of the openings to form plug welds within the openings.

16. The method of claim 15, further comprising protecting weld beads of the plug welds against wear and damage by locating the weld beads fully within the openings.

17. The method of claim 15, further comprising reducing or eliminating delamination of the body panels by forming the plug welds within the openings.

18. The method of claim 13, further comprising welding along edges of the plurality of body panels at the plurality of laminated seams to join adjacent and overlapping body panels at the plurality of laminated seams.

19. The method of claim 13, further comprising lining an inside surface of the shell portion with a wear-resistant material that is harder than a material of the shell portion.

20. The method of claim 13, further comprising assembling the dump body from two or more modular portions, each modular portion comprising a plurality of body panels.
